(19) United States
(12) Patent Application Publication
(10) Pub. No.: US 2017/0164640 A1
(43) Pub. Date: Jun. 15, 2017

(54) CEREAL FOODSTUFFS, CEREAL FOOD PRODUCTS, AND METHODS OF MANUFACTURE THEREOF

(71) Applicant: Nahum JEANNOT, Falls Church, VA (US)

(72) Inventor: Nahum JEANNOT, Falls Church, VA (US)

(21) Appl. No.: 14/959,240

(22) Filed: Dec. 4, 2015

(51) Int. Cl. A23L 1/36; A23C 9/18

(52) U.S. Cl. CPC A23L 1/1643; A23L 1/2123; A23L 1/1033; A23C 9/18; A23V 2002/00

(57) ABSTRACT

A shaped, self-sustaining cereal product is formed from a mixture of cereal and a thickener, such as a milk. Aspects include forming the cereal product from a mixture that has been cooked, cooled, shaped, frozen, breaded, and then fried. Aspects also include forming a mixture that contains milk but with little or no water.

### FIELD

The disclosure relates to cereal foodstuffs and methods of manufacturing cereal foodstuffs. In particular, the disclosure relates to cereal foodstuffs formed by cooking a mixture comprising cereal and a liquid thickener, and methods of manufacturing the same. The disclosure also relates to cereal foodstuffs having an outer layer, such as a breaded coating, and to cereal food products that are fried, and methods of manufacturing the same.

### BACKGROUND

Cereal products are generally well-known and available in a variety of forms. Cereal products are widely understood to provide dietary benefits. By way of example, oatmeal is high in soluble fiber, which has been shown to promote cardiac health, and reduce total cholesterol levels. Oatmeal is also rich in calcium and potassium, which has been linked to blood pressure reduction, and decreased rises in blood sugar.

### SUMMARY

There exists a need for cereal foodstuffs that are suitable for convenient storage, carrying, and consumption while the consumer is mobile, such as cereal foodstuffs having a soft consistency, fresh taste, simple composition. There is also a need for cereal foodstuffs, food products, including bite size food products, and methods of manufacturing the same with ingredients, including whole or substantially whole fresh fruit, in the interior of the foodstuff.

An aspect of the disclosure may include a method for forming a cereal foodstuff. Another aspect of the disclosure may include a method for forming a cereal food product. Another aspect of the disclosure is a cereal foodstuff having a cereal mixture and an outer coating. Additional aspects and other features of the disclosure will be set forth in the description that follows and in part will be apparent to those having ordinary skill in the art upon examination of the following or may be learned from the practice of the present disclosure. The advantages of the present disclosure may be realized and obtained as particularly pointed out in the appended claims.

According to the disclosure, some technical effects may be achieved in part by a method including forming a mixture including a cereal and a liquid thickener, cooking the mixture until al dente but slightly creamy, and cooling the mixture. The cooled mixture may be formed into a desired shaped foodstuff. An aspect of the disclosure may include cooling the shaped foodstuff. Another aspect of the disclosure may include coating the cooled foodstuff, and frying the coated foodstuff to form a food product. Another aspect of the disclosure may include the fried, coated food product being frozen for future consumption.

Aspects of the disclosure may include cereal foodstuffs and cereal food products formed in accordance with the foregoing methods. In an aspect of the disclosure, the cereal may include a starchy cereal. The cereal may be one or more of oats, steel cut oats, grits, quinoa, and cream of wheat. Another aspect of the disclosure may include the liquid thickener being milk. The mixture may include fresh fruit, butter, and sugar.

Additional features and technical effects of the present disclosure will become readily apparent to those skilled in the art from the following detailed description wherein embodiments of the present disclosure are described by way of illustration of the best mode contemplated to carry out the present disclosure. The disclosure covers various other and different embodiments, and its several details are capable of modifications in various obvious respects, all without departing from the present disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 shows a method for making a cereal foodstuff and a cereal food product in accordance with an exemplary embodiment;

FIG. 2 shows a diagrammatical cross-section of a cereal foodstuff and a cereal product in accordance with an exemplary embodiment;

FIG. 3 shows shapes for a cereal foodstuff and a cereal food product in accordance with exemplary embodiments;

FIG. 4 shows shapes for a cereal foodstuff and a cereal food product in accordance with exemplary embodiments;

FIG. 5 shows shapes for a cereal foodstuff and a cereal food product in accordance with exemplary embodiments.

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with an equivalent arrangement. In addition, unless otherwise indicated, all numbers expressing quantities, ratios, and numerical properties of ingredients, reaction conditions, and so forth used in the specification and claims are to be understood as being modified in all instances by the term “about”.

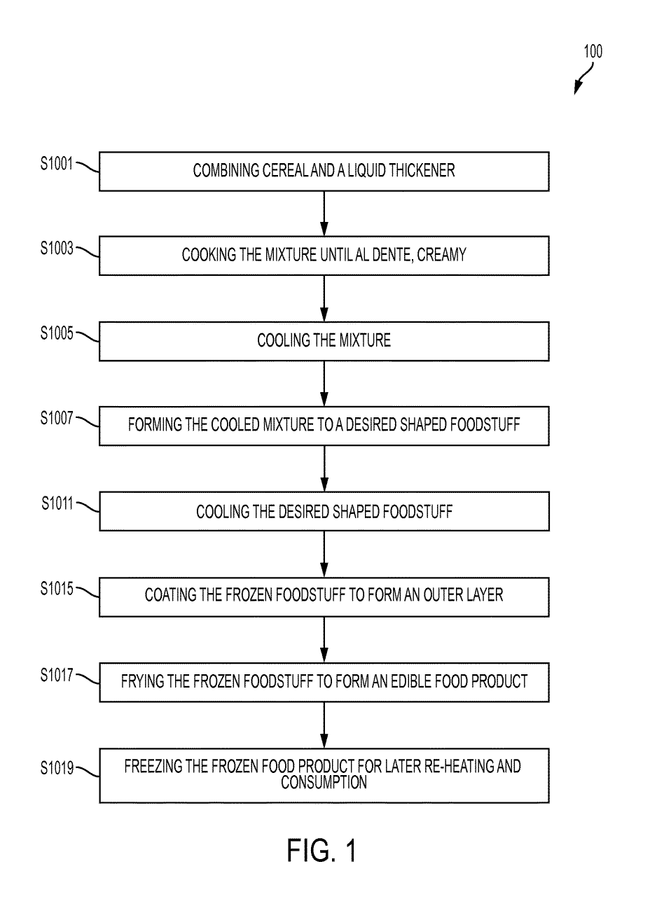

FIG. 1 shows a method 100 for forming a cereal foodstuff and food product in accordance with an aspect of the disclosure. The method 100 includes combining cereal and a liquid thickener at S1001. The liquid thickener at least contributes to thickening and binding of the mixture. For example, starch in the cereal, sugar, and the liquid thickener may contribute in combination to thickening or binding of the mixture. In an embodiment, the cereal may be a starchy cereal. The cereal may be a cereal or combination of cereals selected from the group consisting oats, steel cut oats, grits, quinoa, and cream of wheat. The cereal may be, for example, steel cut oats. The cereal may be present in the mixture in amount of 15% by weight to 20% by weight or, by parts, 3 cups milk to 1 cup cereal, or 4 cups milk to 1 cup cereal, for example.

Aspects include employing a liquid thickener that is not water. The liquid thickener may be a liquid selected from the group consisting of dairy milk, goat milk, coconut milk, almond milk, cashew milk, and rice milk. Other liquid thickeners, such as non-aqueous liquids, thickeners, may be used in accordance with various aspects of the disclosure. The term “non-aqueous” is intended to exclude water as a separate ingredient of the mixture.

Another aspect of the disclosure includes forming a mixture with a cereal, thickener, and a small amount of water. Embodiments include forming the mixture with an amount of water such that the moisture content in the final cereal product that is attributable to the amount of water added is less than 35%, such as less than 20%, e.g., less than 5%.

Aspects of the disclosure include adding one or more spice ingredients to the mixture before cooking the mixture. For example, nutmeg, cinnamon, or other spices may be added to the mixture.

Aspects of the disclosure also include adding butter and sugar to the mixture. Butter or sugar, each alone or in combination, may contribute to binding or thickening or otherwise affect the consistency of the mixture along with the cereal. For example, butter may be added to the mixture in an amount of 3% by weight to 10% by weight. Sugar may be added to the mixture in an amount of 2% by weight to 15% by weight.

Methods according to the disclosure include cooking the mixture until al dente, but slightly creamy, as shown in FIG. 1 at S1003. The mixture may be cooked by heating at an appropriate temperature, such as at a temperature in a range of 140 degrees Fahrenheit to 200 degrees Fahrenheit, or 300 degrees Fahrenheit to 375 degrees Fahrenheit, such as for a period of about 30 minutes to a period of about one hour and 15 minutes. Flavorings may be added while cooking at S1003, such as nutmeg, vanilla, apples, and other flavorings.

The cooked mixture may then be cooled at S1005, for example, under refrigeration at 41 degrees Fahrenheit or below temperature. Aspects include adding flavor enhancing ingredients and fresh fruit, including cooked fresh fruit, dried nuts, or other ingredients, prior to cooling. Any suitable complimentary fruit may be added, such as at least one selected from the group consisting of blueberries, bananas, cranberries, apples.

Aspects of the disclosure include cooling the cooked mixture to a temperature below 41 degrees Fahrenheit at S1005. In an embodiment, the mixture may be cooled for a minimum period of eight hours or until the mixture has set. Aspects include forming the cooked mixture such that its moisture content, due to non-aqueous ingredients, is within the range of about 55% to about 63%, such as about 55% to about 63%.

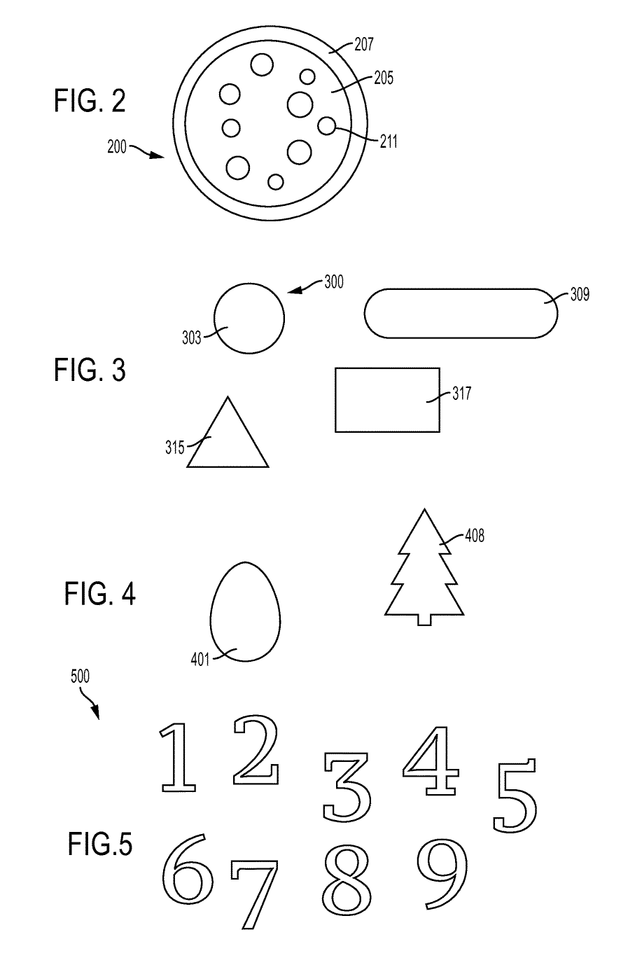

The cooled mixture may be shaped at S1007 to form a shaped foodstuff. Aspects include forming the cooled mixture into a shape that is suitable for hand-held consumption, or that is suitable for convenient consumption when the consumer is mobile or active. For example, FIG. 2 shows a diagrammatical cross-sectional view of a spherical-shaped cereal food product 200. The food product 200 includes an interior 205 composed of the cooked mixture. The cooked mixture of the interior 205 is covered by an exterior 207 or outer coating, which may be composed of a breading, for example, as discussed below. The interior 205 may include fruit 211 or other ingredients dispersed throughout the mixture of the interior 205.

The cooled mixture may be formed into any desired shape. For example, as shown in FIG. 3, the cooled mixture may be formed into shapes 300. Shapes 300 may include a spherical shape 303, a cylinder 309, a pyramid 315, or a square 317. Aspects of the disclosure include forming the cooled mixture into an appropriately colored and seasonal shaped item, as shown in FIG. 4, such as an egg shape 401 for Easter, or a small green tree 408 for Christmas festivities, as shown in FIG. 4. Aspects also include forming the cooled mixture into a numeral, as shown in FIG. 5, for enjoyment at birthday parties, e.g., for children. FIG. 5 shows, for example, numeral shapes 500 including shaped numerals one through nine.

The shaped foodstuff may be cooled or frozen at S1011. Aspects include cooling the shaped foodstuff to a temperature of 41 degrees Fahrenheit or lower, or by flash freezing. For example, the foodstuff may be cooled at a temperature of 41 degrees Fahrenheit or below at S1011 or frozen at 32 degrees Fahrenheit or lower. The cooled or frozen foodstuff may be coated with a breading or outer layer of ingredients at S1015. For example, the outer layer may be formed of any complementary ingredients, such as at least one ingredient selected from the group consisting of graham crackers, panko, nuts, legumes, wheat flour, corn flour, corn flakes, egg, breadcrumbs, and corn.

Aspects of the disclosure may also include storing after S1011 or after S1015 for later reheating, shipment, sales, or other processing. In an embodiment, the shaped foodstuff may be cooled at S1011 immediately before coating the cooled or frozen foodstuff at S1015, and immediately before packaging.

According to another aspect of the disclosure, the coated, frozen foodstuff may be fried to form an edible food product at S1017. For example, the coated, frozen foodstuff may be oven-fried, pan-fried, deep-fried, or baked to form an edible food product. Embodiments include frying the foodstuff at a temperature of about 300 degrees Fahrenheit to about 400 degrees Fahrenheit for a period of 30 seconds to about two minutes.

The fried food product may be frozen at S1019. Aspects of the disclosure may include freezing the food product. The food product may be cooled to a temperature below 32 degrees Fahrenheit for a period of four hours or more to freeze the food product. For example, the fried food product may be cooled at a temperature of 32 degrees Fahrenheit. The frozen fried product may be stored or saved for later consumption, for transport or delivery, sale, or other future activities. The frozen fried food product may be prepared for consumption by reheating in any convenient manner, as by baking, such as at, a temperature of about 300 degrees Fahrenheit to about degrees Fahrenheit, e.g., 400 degrees Fahrenheit for a period of about 15 minutes to about 25 minutes. The food product may also be reheated by microwave or by frying. For example, a bite size food product may be cooked in accordance with methods of an embodiment for reheating by microwaving on high heat for a period of 20 seconds to 1 minute or until hot.

Aspects of some embodiments are illustrated by the following examples:

### Example 1

| Ingredient | Weight Percent |
|---|---|
| Milk | 63.0% |
| Sugar | 13.0% |
| Oats | 18.0% |
| Butter | 5.00% |
| Salt | 0.08% |
| Flour | 0.00008% |
| Egg | 0.00008% |
| Panko | 0.00008% |

A cereal food product in accordance with an exemplary embodiment may be made using the ingredients shown above in Example 1. The ingredients are shown with corresponding weight percentages.

A cereal food product in accordance with another exemplary may be made using the ingredients shown below in Example 2. The ingredients are shown with corresponding weight percentages.

### Example 2

| Ingredient | Weight Percent |
|---|---|
| Milk | 55.0% |
| Sugar | 11.0% |
| Oats | 16.0% |
| Butter | 4.00% |
| Salt | 0.07% |
| Dried Cranberries | 13.0% |
| Flour | 0.00008% |
| Egg | 0.00008% |
| Panko | 0.00008% |
| Walnuts | 0.00008% |

In the preceding description, the present disclosure is described with reference to specifically exemplary embodiments thereof. It will, however, be evident that various modifications and changes may be made thereto without departing from the broader spirit and scope of the present disclosure, as set forth in the claims. The specification and drawings are, accordingly, to be regarded as illustrative and not as restrictive. It is understood that the present disclosure is capable of using various other combinations and embodiments and is capable of any changes or modifications within the scope of the inventive concept as expressed herein.

What is claimed is:

1. A method, comprising:
forming a mixture comprising a cereal and a liquid thickener;
cooking the mixture until al dente but slightly creamy;
cooling the mixture; and
forming the cooled mixture into a desired shaped foodstuff.

2. The method according to claim 1, comprising cooling the shaped foodstuff.

3. The method according to claim 2, comprising freezing the shaped foodstuff.

4. The method according to claim 2, comprising applying an outer coating to the frozen foodstuff to form a coated frozen foodstuff.

5. The method according to claim 4, comprising deep-frying the coated frozen foodstuff to form an edible food product.

6. The method according to claim 5, comprising freezing the edible food product for future consumption.

7. The product produced by the process of claim 6.

8. The method according to claim 1, comprising forming a mixture comprising a cereal and milk as the liquid thickener.

9. The method according to claim 8, comprising forming a mixture comprising a starchy cereal.

10. The method according to claim 9, comprising forming a mixture comprising a starchy cereal selected from the group consisting of oats, steel cut oats, grits, quinoa, and cream of wheat.

11. The method according to claim 10, comprising forming a mixture comprising steel cut oats as the starchy cereal.

12. The method according to claim 10, comprising adding a flavor enhancing ingredient to the mixture prior to cooling.

13. The method according to claim 12, comprising adding at least one cooked fresh fruit, at least one dried nut, and/or at least one spice ingredient to the mixture prior to cooling.

14. The method according to claim 12, comprising adding at least one member selected from the group consisting of blueberries, bananas, cranberries, apples, and nuts to the mixture prior to cooling.

15. The method according to claim 12, forming the cooled mixture into a cylinder, square, stick, or spherical shape.

16. The product produced by the method of claim 15.

17. The method according to claim 1, comprising forming the mixture with a non-aqueous thickener.

18. The method according to claim 1, comprising forming the mixture without water.

19. A shaped, self-sustaining cereal product comprising a mixture of cereal and milk that has been cooked, cooled, shaped, frozen, breaded then fried.

20. The cereal product according to claim 17, wherein the mixture was formed without water.
